(19) United States
(12) Patent Application Publication
(10) Pub. No.: US 2023/0281129 A1
(43) Pub. Date: Sep. 7, 2023

(54) INFORMATION PROCESSING APPARATUS AND MEMORY ACCESS CONTROL METHOD

(71) Applicant: Fujitsu Limited, Kawasaki-shi (JP)

(72) Inventor: Ken IIZAWA, Yokohama (JP)

(73) Assignee: Fujitsu Limited, Kawasaki-shi (JP)

(21) Appl. No.: 18/066,061

(22) Filed: Dec. 14, 2022

(30) Foreign Application Priority Data
Mar. 1, 2022 (JP) 2022-030617

(51) Int. Cl. G06F 12/084; G06F 12/0877; G06N 5/04

(52) U.S. Cl. CPC G06F 12/084; G06F 12/0877; G06N 5/04

(57) ABSTRACT

An information processing apparatus includes: calculation circuits that each executes deep learning; a shared memory that is shared by the calculation circuits; an access information memory that holds, for each of the calculation circuits, a write request for writing data generated in forward propagation processing by the calculation circuits to the shared memory, a read request for reading the data used in backward propagation processing by the calculation circuits from the shared memory, and a start time of backward propagation processing; and a processor that schedules data transfer between the calculation circuits and the shared memory based on the write request, the read request, and the start time of backward propagation processing such that the data is transferred from the shared memory to a calculation circuit that executes backward propagation processing by the start time of backward propagation processing, and accesses the shared memory based on a scheduling result.

### CROSS-REFERENCE TO RELATED APPLICATION

This application is based upon and claims the benefit of priority of the prior Japanese Patent Application No. 2022-30617, filed on Mar. 1, 2022, the entire contents of which are incorporated herein by reference.

### FIELD

The embodiment discussed herein is related to an information processing apparatus and a memory access control method.

### BACKGROUND

A system is known that includes a shared cache and a shared memory shared by a plurality of calculators, and improves access performance by transferring data from the shared memory to the shared cache in advance based on the history of memory access of the calculators.

Japanese Laid-open Patent Publication No. 6-324942 and Japanese Laid-open Patent Publication No. 2005-157711 are disclosed as related art.

### SUMMARY

According to an aspect of the embodiments, an information processing apparatus includes: a plurality of calculation circuits that each executes deep learning; a shared memory that is shared by the plurality of calculation circuits; an access information memory that holds, for each of the plurality of calculation circuits, a write request for writing data generated in forward propagation processing by the plurality of calculation circuits to the shared memory, a read request for reading the data used in backward propagation processing by the plurality of calculation circuits from the shared memory, and a start time of backward propagation processing; and a processor that schedules data transfer between the plurality of calculation circuits and the shared memory based on the write request, the read request, and the start time of backward propagation processing held in the access information memory such that the data is transferred from the shared memory to a calculation circuit that executes backward propagation processing by the start time of backward propagation processing, and accesses the shared memory based on a scheduling result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of an information processing apparatus according to an embodiment;

FIG. 2 is an explanatory diagram illustrating an example of an address space of the information processing apparatus in FIG. 1;

FIG. 3 is an explanatory diagram illustrating an example of a request queue in FIG. 2;

FIG. 4 is an explanatory diagram illustrating an example of a free space management table in FIG. 2;

FIG. 5 is an explanatory diagram illustrating an example of a method for calculating a start time of backward propagation processing and a prefetch start time in FIG. 3;

FIG. 6 is an explanatory diagram illustrating an example of training of a DNN by the information processing apparatus in FIG. 1;

FIG. 7 is a flowchart illustrating an example of processing executed by each workload in FIG. 1 before training of a DNN;

FIG. 8 is a flowchart illustrating an example of the operation of forward propagation processing executed by each workload in FIG. 1;

FIG. 9 is a flowchart illustrating an example of the operation of backward propagation processing executed by each workload in FIG. 1;

FIG. 10 is a flowchart illustrating an example of the operation of a scheduler in FIG. 1;

FIG. 11 is a flowchart illustrating an example of the operation of step S60 in FIG. 10; and

FIG. 12 is a flowchart illustrating a continuation of the operation in FIG. 11.

### DESCRIPTION OF EMBODIMENTS

In training of a deep neural network using backpropagation, a workload that executes the training updates a weight to be used in each layer by executing backward propagation processing using learning data of each layer calculated in forward propagation processing. For example, in training of a deep neural network, there is a case in which learning data generated in forward propagation processing is saved to an external memory, and the learning data is read from the external memory when executing backward propagation processing.

For example, when a plurality of workloads executes training of a plurality of deep neural networks in parallel and a plurality of pieces of learning data is held in a shared memory, contention may occur in accessing the shared memory. When learning data to be used in backward propagation processing is not transferred from the shared memory by the start time of backward propagation processing due to contention for access to the shared memory, the start of backward propagation processing is delayed and the training time increases. Normally, in training of a deep neural network, forward propagation processing and backward propagation processing are repeatedly executed by using a large number of pieces of input data a plurality of times. Accordingly, the delay time of the start of backward propagation processing is accumulated, and the training time further increases.

In one aspect, an object of the present disclosure is to reduce the frequency of a delay in backward propagation processing due to data transfer from a shared memory to a calculation unit being not in time and suppress a decrease in the execution efficiency of deep learning, when data to be used in deep learning by a plurality of workloads is read from and written to the shared memory.

Hereinafter, an embodiment will be described with reference to the drawings.

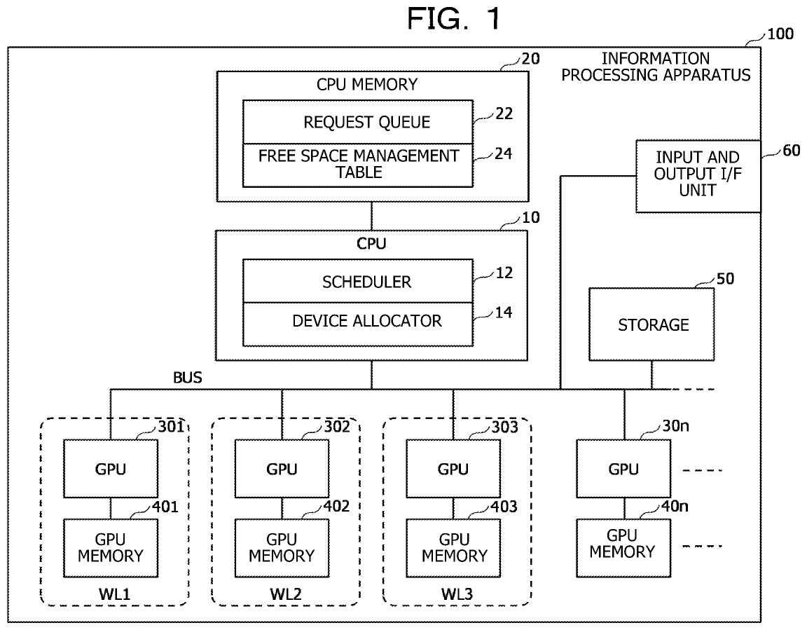

FIG. 1 illustrates an example of an information processing apparatus according to the embodiment. For example, an information processing apparatus 100 illustrated in FIG. 1 is a server capable of executing deep learning. The information processing apparatus 100 includes a central processing unit (CPU) 10, a CPU memory 20, n graphics processing units (GPUs) 30 (301, 302, 303, . . . , 30n), and n GPU memories 40 (401, 402, 403, . . . , 40n). The information processing apparatus 100 includes a storage 50 and an input and output interface (I/F) unit 60.

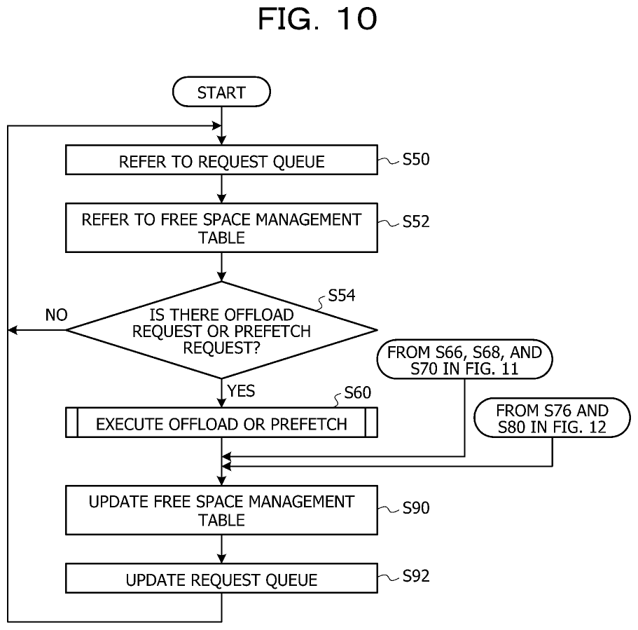

The CPU 10 controls the entire information processing apparatus 100, and functions as a scheduler 12 and a device allocator 14 by executing programs. The scheduler 12 is an example of a scheduling unit. When a workload WL to be described later executes deep learning, the scheduler 12 determines the order of data transfer between each GPU memory 40 and the CPU memory 20 and the like based on a scheduling policy, and executes data transfer in accordance with the determined order. An example of the operation of the scheduler 12 will be described with reference to FIGS. 10 to 12.

For each workload WL, the device allocator 14 allocates an area of the CPU memory 20 to be used in the workload WL. Allocation by the device allocator 14 will be described later. The programs for implementing the scheduler 12 and the device allocator 14 are stored in the CPU memory 20 and executed by the CPU 10.

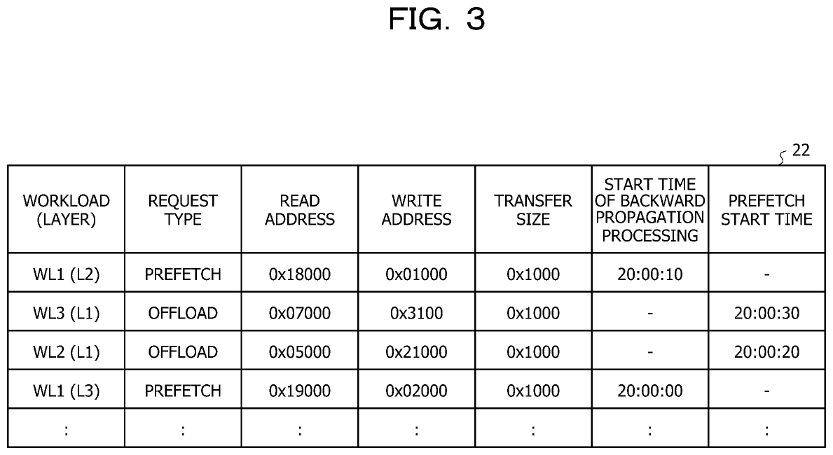

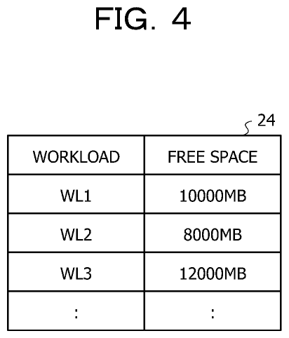

The CPU memory 20 is a shared memory that is coupled to the CPU 10 and is accessible from each GPU 30. For example, areas of a request queue 22 and a free space management table 24 are allocated to the CPU memory 20. An example of the request queue 22 is illustrated in FIG. 3, and an example of the free space management table 24 is illustrated in FIG. 4. The request queue 22 is an example of an access information holding unit, and the free space management table 24 is an example of a free space holding unit.

Although not particularly limited, for example, the CPU memory 20 may be a memory module such as a dynamic random-access memory (DRAM). Instead of the CPU memory 20, a Compute Express Link (CXL) memory corresponding to the CXL standard or the like may be coupled to the input and output I/F unit 60. In this case, the input and output I/F unit 60 includes a Peripheral Component Interconnect Express (PCIe) port.

Each of the plurality of GPUs 30 is capable of executing training of a deep neural network. Hereinafter, deep neural network is also referred to as DNN, and training of deep neural network is also referred to as deep learning. The GPU 30 and the GPU memory 40 having the same last digits are coupled to each other and may operate as a workload WL (WL1, WL2, WL3) that executes deep learning. A workload WL is an example of a calculation unit that executes deep learning. One calculation unit may be constructed by a plurality of GPUs 30 and a plurality of GPU memories 40, or a plurality of calculation units may be constructed by one GPU 30 and one GPU memory 40.

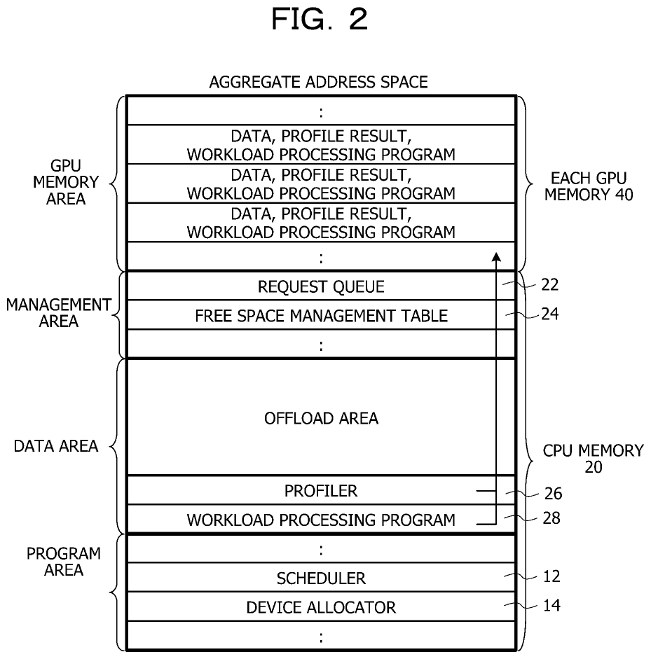

Each GPU 30 is coupled to the CPU 10 via a bus BUS, and may access the CPU memory 20 via the CPU 10. For example, the GPU memory 40 holds training data (input data such as image data) and parameters such as weights to be used in deep learning, and a profiler 26 and a workload processing program 28 illustrated in FIG. 2. Although not particularly limited, the GPU memory 40 may be a static random-access memory (SRAM). The GPU memory 40 is an example of an individual memory.

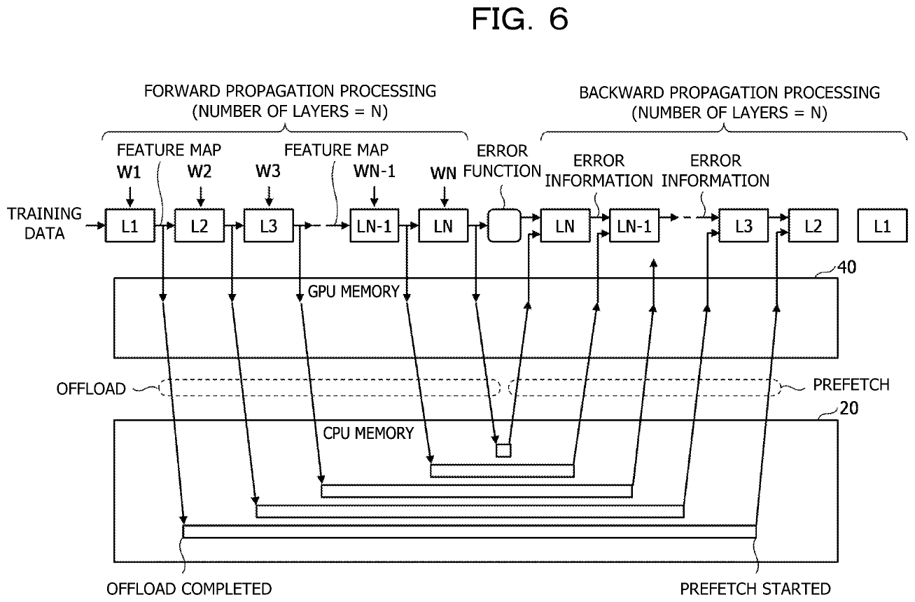

Each workload WL (GPU 30) executes forward propagation processing and backward propagation processing of deep learning by executing a workload processing program. In forward propagation processing of deep learning, a workload WL generates a feature map for each layer of a deep neural network by using a weight W (FIG. 6). In backward propagation processing of deep learning, each workload WL generates error information in each layer by using a feature map generated in forward propagation processing, and updates the weight W by the generated error information. A feature map is an example of data used in forward propagation processing and backward propagation processing.

Each workload WL stores a feature map generated in forward propagation processing in the GPU memory 40. Based on the information held in the request queue 22, the feature map stored in the GPU memory 40 is transferred from the GPU memory 40 to the CPU memory 20 by the scheduler 12. Based on the information held in the request queue 22, the feature map held in the CPU memory 20 is transferred from the CPU memory 20 to the GPU memory 40 by the scheduler 12 before backward propagation processing is executed.

Hereinafter, transfer (writing) of a feature map from the GPU memory 40 to the CPU memory 20 is also referred to as offload. Transfer (reading) of a feature map from the CPU memory 20 to the GPU memory 40 is also referred to as prefetch.

Each workload WL stores an offload request for offloading a feature map from the GPU memory 40 to the CPU memory 20 in the request queue 22 for each layer of forward propagation processing. Each workload WL stores a prefetch request for prefetching a feature map from the CPU memory 20 to the GPU memory 40 in the request queue 22 for each layer of the backward propagation processing. For example, the timing at which each workload WL stores an offload request and a prefetch request in the request queue is before starting deep learning in each layer.

For example, the storage 50 is coupled to the bus BUS. The storage 50 holds various programs (such as the scheduler 12, the device allocator 14, the profiler 26, and the workload processing program 28) and image data to be used for deep learning so that the programs and image data may be loaded. Various programs may be stored in a recording medium (not illustrated) coupled to the input and output I/F unit 60, downloaded from the recording medium to the storage 50, and loaded into the CPU memory 20 or the GPU memory 40. For example, the input and output I/F unit 60 is coupled to the bus BUS.

In this embodiment, calculation of forward propagation processing and backward propagation processing is executed by the GPU 30, and data transfer between the GPU memory 40 and the CPU memory 20 is executed by the CPU 10 (scheduler 12). For this reason, calculation of forward propagation processing and backward propagation processing and data transfer may be executed in parallel. Accordingly, if offload and prefetch may be executed in the background of calculation of forward propagation processing and the backward propagation processing, an increase in the processing time of deep learning by a workload WL due to data transfer may be suppressed.

For example, in forward propagation processing and backward propagation processing of each workload WL, average memory access performance b(w) for hiding the memory access time for accessing the CPU memory 20 is calculated by formula (1).

b(w)=(DTo+DTp)/CAL (1)

In formula (1), reference sign DTo indicates the total data size of feature maps offloaded to the CPU memory 20, and reference sign DTp indicates the total data size of feature maps prefetched from the CPU memory 20. The total data sizes DTo and DTp of feature maps may be equal to each other. In formula (1), reference sign CAL indicates the total calculation time of forward propagation processing and backward propagation processing of each workload WL. As the specifications of deep learning, the total data sizes DTo and DTp and the total calculation time CAL are input to the device allocator 14 from the outside of the information processing apparatus 100.

In practice, since the size of a feature map, the time taken for offload and prefetch, and the calculation time by a workload WL are different for each layer, there may be a layer in which the time taken for offload and prefetch may not be hidden. However, for simplification, it is assumed that the sizes of feature maps generated in all layers of a deep neural network are the same as each other, and the calculation times in the layers are the same as each other.

For each workload WL, the device allocator 14 allocates an area of the CPU memory 20 to which a feature map is offloaded such that average memory access performance b(w) does not exceed the bandwidth B between the CPU 10 and the CPU memory 20. For example, the device allocator 14 sets, as a bandwidth to be allocated to each workload WL, B/m obtained by dividing the bandwidth B by the number m of workloads WL executed in parallel. The bandwidth B/m indicates transfer performance when the scheduler 12 offloads a feature map and prefetches a feature map.

As the specifications of deep learning, the device allocator 14 may notify the outside of the information processing apparatus 100 of the area of the CPU memory 20 allocated for each workload WL. Based on the specifications of deep learning, each workload WL sets information such as memory address in the request queue 22 illustrated in FIG. 3.

FIG. 2 illustrates an example of an address space of the information processing apparatus 100 in FIG. 1. The address space of the information processing apparatus 100 is an aggregate address space commonly accessed by the CPU 10 and each GPU 30. A GPU memory area used by each GPU 30, a management area, a data area, and a program area in which programs executed by the CPU 10 are stored are allocated to the address space. The GPU memory area belongs to each GPU memory 40. The management area, the data area, and the program area belong to the CPU memory 20.

In the GPU memory area, various data such as feature maps and weights, a profile result, a workload processing program executed by a workload WL, a profiler (not illustrated) transferred from the data area, and the like are stored for each GPU 30. A profile result is obtained by the profiler 26 executed by the GPU 30.

In the management area, the request queue 22 and the free space management table 24 are stored. In the data area, an offload area for holding a feature map offloaded from the GPU memory 40, the profiler 26, and the workload processing program 28 are stored. In the program area, the scheduler 12, the device allocator 14, and the like executed by the CPU 10 are stored.

The profiler 26 is executed together with a workload WL temporarily executed by each GPU 30 before executing deep learning, and acquires information on the workload WL. For example, the temporary workload WL executes several tens of iterations. For example, training of a deep neural network may include several millions of iterations for datasets having the same size. Even by several tens of iterations, the behavior of a workload WL may be profiled.

Information obtained by profiling includes reading time T_{INPUT}, calculation time T_{F}(i) in a layer i in forward propagation processing, calculation time T_{B}(i) in the layer i in backward propagation processing, and size s(i) of the feature map of the layer i. Reading time T_{INPUT} is time taken for transferring training data (input data) from the storage 50 or the like to the GPU memory 40. A feature map is input to the layer i excluding an input layer and is used for the calculation in the layer i in forward propagation processing and backward propagation processing.

FIG. 3 illustrates an example of the request queue 22 in FIG. 2. The request queue 22 includes a plurality of entries in each of which an offload request or a prefetch request is stored. Each entry includes an area for holding, for each layer, identifiers of a workload WL and a layer L, a request type, a read address, a write address, a transfer size, a start time of backward propagation processing, and a prefetch start time.

Reference sign “0x” added before the numerical values of read addresses, write addresses, and transfer sizes indicates that the numerical value is a hexadecimal number. For example, a start time of backward propagation processing and a prefetch start time are elapsed times with respect to a transfer start time of training data to be used for deep learning from the storage 50, and are indicated by hours:minutes:seconds. In an offload request, the read address indicates the address of the GPU memory 40, and the write address indicates the address of the CPU memory 20. In a prefetch request, the read address indicates the address of the CPU memory 20, and the write address indicates the address of the GPU memory 40. For example, the unit of a transfer size is megabytes.

For example, every time calculation in the layer L ends, each workload WL stores each of the information of an offload request and the information of a prefetch request in any of the entries together with the identifiers of the own workload WL and the layer L. Each workload WL stores a prefetch start time in an entry together with the information of an offload request. Each workload WL stores a start time of backward propagation processing in an entry together with information of a prefetch request. Each workload WL calculates the information of an offload request and the information of a prefetch request stored in the request queue 22 before starting deep learning.

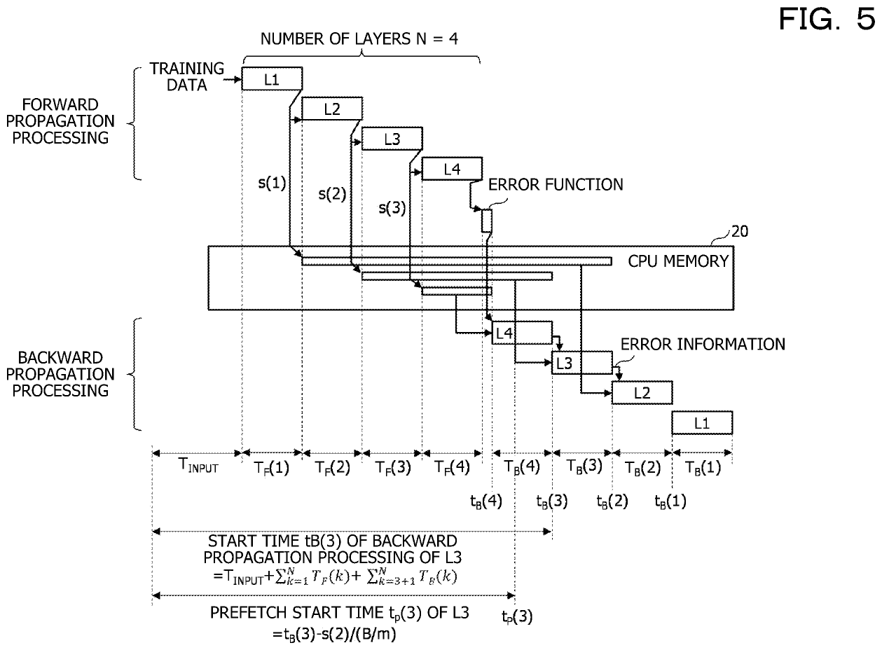

Each workload WL calculates a write address in an offload request and a read address in a prefetch request in accordance with the address range of a memory area of the CPU memory 20 allocated for each workload WL by the device allocator 14. Each workload WL calculates a transfer size, a start time of backward propagation processing, and a prefetch start time based on the information acquired by the profiler 26 executed in each workload WL. A method for calculating a start time of backward propagation processing and a prefetch start time will be described with reference to FIG. 5.

A prefetch start time is a time at which transfer of a feature map from the CPU memory 20 to the GPU memory 40 is started in order to start backward propagation processing, and is set for each layer L of a workload WL. Based on a profiling result, each workload WL determines a prefetch start time to be stored in the request queue 22 such that the completion time of prefetch and the start time of backward propagation processing coincide with each other. To suppress the usage of the GPU memory 40, it is preferable that prefetch be completed immediately before the start time of backward propagation processing. Based on the prefetch start time held in the request queue, the scheduler 12 determines the start time of prefetch.

The scheduler 12 in FIG. 1 detects an offload request when the information of the offload request is stored in any of the entries of the request queue 22. The scheduler 12 detects a prefetch request when the information of the prefetch request is stored in any of the entries of the request queue 22.

FIG. 4 illustrates an example of the free space management table 24 in FIG. 2. The free space management table 24 includes an area for holding the free space of the GPU memory 40 for each workload WL. When work data is generated by forward propagation processing or backward propagation processing, each workload WL decreases the corresponding area of free space by the size of generated data. When work data is deleted due to the end of forward propagation processing or backward propagation processing or the like, each workload WL increases the corresponding area of free space area by the size of deleted data.

When having transferred a feature map from the GPU memory 40 to the CPU memory 20 based on an offload request, the scheduler 12 increases the corresponding area of free space by the transfer size. When having transferred a feature map from the CPU memory 20 to the GPU memory 40 based on a prefetch request, the scheduler 12 decreases the corresponding area of free space by the transfer size.

FIG. 5 illustrates an example of a method for calculating a start time of backward propagation processing and a prefetch start time. FIG. 5 illustrates an example in which a deep neural network includes four layers of L1 to L4. In FIG. 5, illustration of the GPU memory 40 is omitted.

In forward propagation processing, calculation in the layers L1 to L4 is executed in order, and a feature map is generated in each of the layers L1 to L4. Reference signs s(1), s(2), and s(3) indicate the sizes of the feature maps generated in the layers L1, L2, and L3, respectively.

The feature maps generated in the layers L1 to L3 are offloaded from the GPU memory 40 (not illustrated) to the CPU memory 20. The feature map generated in the layer L4 is used for calculation of an error function. Reference signs T_{F}(1) to T_{F}(4) indicate the calculation times in the layers L1 to L4 in forward propagation processing, respectively.

In backward propagation processing, update processing of the weights of the layers L4 to L2 is executed in order. In the layer L4, error information is generated by using the result of calculation of an error function and the feature map generated in the layer L3 in forward propagation processing, and the generated error information is output to the layer L3. In the layer L3, error information is generated by using the error information from the layer L4 and the feature map generated in the layer L2 in forward propagation processing, and the generated error information is output to the layer L2.

In the layer L2, error information is generated by using the error information from the layer L3 and the feature map generated in the layer L1 in forward propagation processing. The weights of the layers L4 to L2 are updated based on the error information. Reference signs T_{B}(4) to T_{B}(1) indicate the calculation times in the layers L4 to L1 in backward propagation processing, respectively. Reference signs t_{B}(4) to t_{B}(1) indicate the start times of backward propagation processing of the layers L4 to L1, respectively. Reference sign tₚ(3) indicates the prefetch start time of the feature map to be used for backward propagation processing of the layer L3 (generated in the layer L2 in forward propagation processing).

In FIG. 5, calculation formula for calculating a start time t_{B}(3) of backward propagation processing of the layer L3 and calculation formula for calculating a prefetch start time tₚ(3) of the feature map to be used for backward propagation processing of the layer L3 are illustrated as examples.

In each workload WL, a start time t_{B}(i) of backward propagation processing of each layer Li is calculated by formula (2) (i is any one of 1, 2, 3, and 4).

t_{B}(i)=T_{INPUT}+Σₖ₌₁^{N}T_{F}(k)+Σₖ₌ᵢ₊₁^{N}T_{B}(k) (2)

As described above, the first term on the right side of formula (2) indicates a transfer time of training data from the storage 50 or the like to the GPU memory 40. The second term on the right side of formula (2) indicates a total sum of calculation times in the layers L1 to L4 in forward propagation processing. The third term on the right side of formula (2) indicates a total sum of calculation times in the layers L4 to Li in backward propagation processing. The calculation time of an error function is sufficiently shorter than the calculation time in each layer L and may be ignored, and thus is omitted in formula (2).

In each workload WL, a prefetch start time tₚ(i) of the feature map to be used for backward propagation processing of each layer Li is calculated by formula (3). As described above, “B/m” in formula (3) indicates a bandwidth to be allocated to each workload WL, and is calculated by dividing the bandwidth B of the CPU memory 20 by the number m of workloads WL.

tₚ(i)=t_{B}(i)−s(i−1)/(B/m) (3)

FIG. 6 illustrates an example of training of a DNN by the information processing apparatus in FIG. 1. FIG. 6 illustrates an example in which a deep neural network includes N layers of L1 to LN. In forward propagation processing of the layer L1, a workload WL generates a feature map by using training data and a weight W1, and outputs the generated feature map to the layer L2. In forward propagation processing of the layers L2 to LN, the workload WL generates feature maps in the layers L2 to LN by using weights W2 to WN, respectively, and outputs each of the generated feature maps to the next layer L. The feature maps generated in the layers L1 to LN and stored in the GPU memory 40 are offloaded to the CPU memory 20 by the scheduler 12.

In backward propagation processing of the layer LN, the workload WL generates error information by using the error information generated by an error function and the feature map generated in forward propagation processing of the layer LN and prefetched from the CPU memory 20, and outputs the generated error information to the layer LN−1. In backward propagation processing of the layer Li, the workload WL generates error information by using the error information generated in the preceding layer Li+1 and the feature map generated in forward propagation processing of the layer Li and prefetched from the CPU memory 20. The layer Li is any one of the layers LN−1 to L2. The weights W of the layers LN to L2 are updated by using the error information.

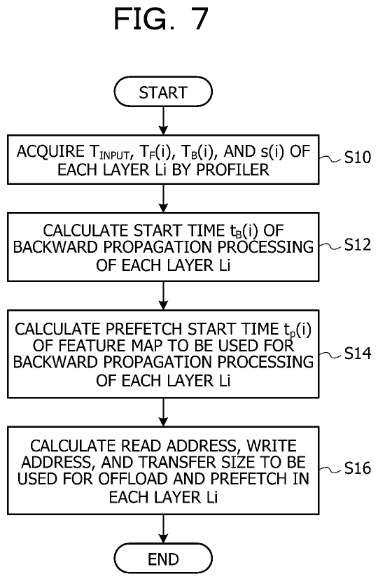

FIG. 7 illustrates an example of processing executed by each workload WL in FIG. 1 before training of a DNN. The processing illustrated in FIG. 7 is realized by each workload WL executing the workload processing program 28.

First, in step 810, for example, a workload WL executes several tens iterations of forward propagation processing and backward propagation processing while operating the profiler 26. The workload WL acquires the reading time T_{INPUT}, calculation time T_{F}(i) in forward propagation processing, calculation time T_{B}(i) in backward propagation processing, and size s(i) of the feature map of each layer i.

Next, in step 812, the workload WL calculates a start time t_{B}(i) of backward propagation processing of each layer Li by using the formula (2) described above. Next, in step 814, the workload WL calculates a prefetch start time tₚ(i) of the feature map to be used for backward propagation processing of each layer Li by using the formula (3) described above.

Next, in step S16, the workload WL calculates a read address, a write address, and a transfer size to be used for offload and prefetch in each layer Li, and ends the processing illustrated in FIG. 7.

The start time t_{B}(i) of backward propagation processing, prefetch start time tₚ(i), read address, write address, and transfer size of each layer Li calculated by each workload WL are stored in the request queue 22 before execution of forward propagation processing. Accordingly, the scheduler 12 may appropriately control the operation of offload and prefetch by using the request queue 22 in which information in a state close to the state at the time of execution of deep learning is held.

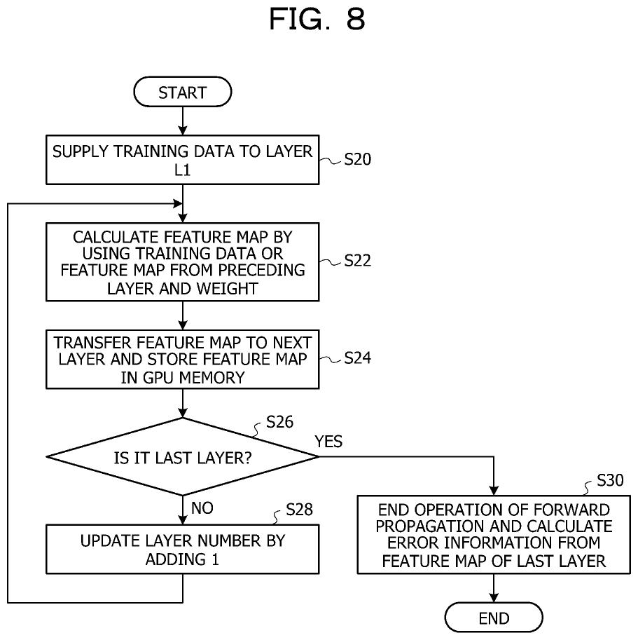

FIG. 8 illustrates an example of the operation of forward propagation processing executed by each workload WL in FIG. 1. The processing illustrated in FIG. 8 is realized by each workload WL executing the workload processing program 28.

First, in step S20, a workload WL supplies training data to the layer L1. Next, in step S22, the workload WL calculates a feature map in the layer L of interest by using the training data or the feature map from the preceding layer L and the weight.

Next, in step S24, the workload WL transfers the calculated feature map to the next layer L and stores the feature map in the GPU memory 40. Next, in step S26, the workload WL determines whether the layer L in which calculation is performed is the last layer L. When the layer L is the last layer L, the workload WL proceeds to step S30. When the layer L is not the last layer L, the workload WL proceeds to step S28.

In step S28, the workload WL updates the layer number by adding 1, and returns to step S22. In step S30, the workload WL ends the forward propagation processing, inputs the feature map generated by the calculation in the last layer L to an error function, causes the error function to calculate error information, and ends the processing illustrated in FIG. 8.

Although the processing of step S30 is not forward propagation processing, it is included in the processing in FIG. 8 for convenience. Although not illustrated in FIG. 8, in the forward propagation processing, the workload WL updates the free space held in the free space management table 24 when work data is generated and stored in the GPU memory 40 and when work data is deleted from the GPU memory 40.

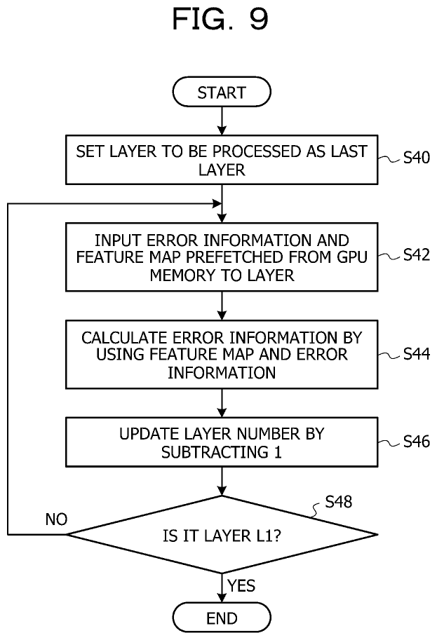

FIG. 9 illustrates an example of the operation of backward propagation processing executed by each workload WL in FIG. 1. The processing illustrated in FIG. 9 is realized by each workload WL executing the workload processing program 28.

First, in step S40, a workload WL sets the layer L to be processed as the last layer L. Next, in step S42, the workload WL inputs, to the layer L to be processed, the error information generated by an error function or the error information generated in the preceding layer L (having the next layer number) and the feature map prefetched from the GPU memory 40. The feature map prefetched from the GPU memory 40 is a feature map generated in forward propagation processing of the layer L to be processed.

Next, in step S44, the workload WL calculates error information by using the feature map and the error information in the layer L to be processed. Next, in step S46, the workload WL updates the layer number by subtracting 1. Next, in step S48, the workload WL determines whether the updated layer number indicates the layer L1. When the layer number indicates the layer L1, the workload WL ends the processing illustrated in FIG. 9. When the layer number indicates a layer other than the layer L1, the workload WL returns to step S42.

Although not illustrated in FIG. 9, in the backward propagation processing, the workload WL updates the free space held in the free space management table 24 when work data is generated and stored in the GPU memory 40 and when work data is deleted from the GPU memory 40.

FIGS. 10 to 12 illustrate an example of the operation of the scheduler 12 in FIG. 1. The processing illustrated in FIGS. 10 to 12 is realized by the CPU 10 executing the program of the scheduler 12. The processing illustrated in FIGS. 10 to 12 is an example of a memory access control method of the information processing apparatus 100.

In one workload WL, offload in the layer L having a relatively large layer number is not executed before offload in the layer L having a relatively small layer number. Similarly, in one workload WL, prefetch in the layer L having a relatively small layer number is not executed before prefetch in the layer L having a relatively large layer number.

First, in step S50, the scheduler 12 refers to the request queue 22 in FIG. 3. Next, in step S52, the scheduler 12 refers to the free space management table 24.

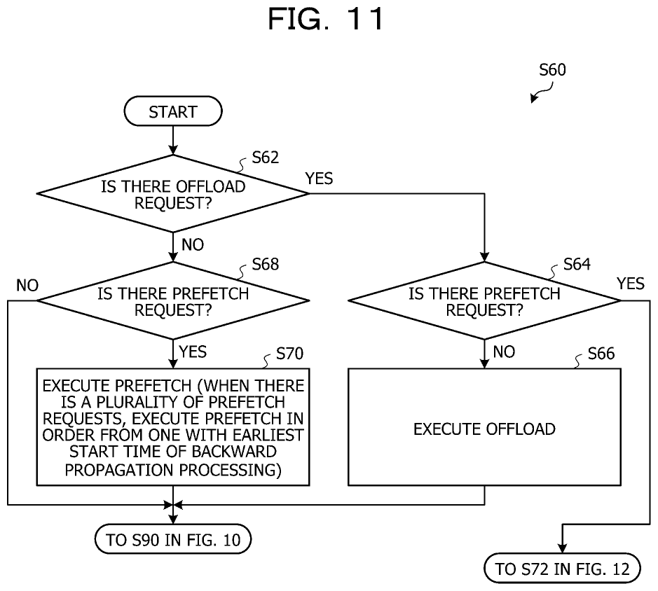

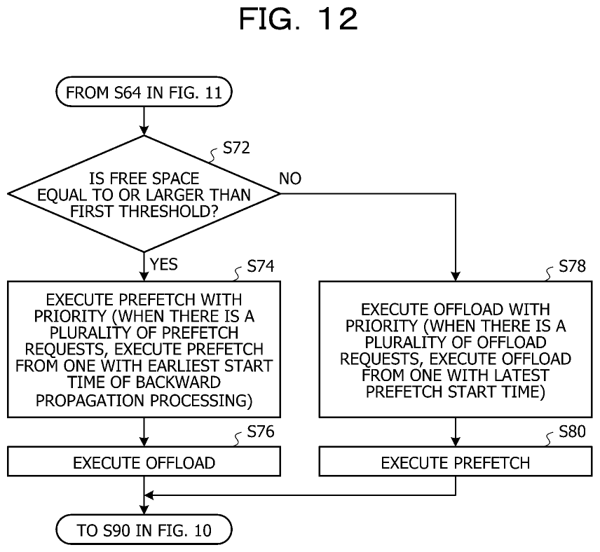

Next, in step S54, the scheduler 12 performs step S60 when an offload request or a prefetch request is stored in the request queue 22, or returns to step S50 when no offload request and prefetch request are stored. An example of the processing of step S60 is illustrated in FIGS. 11 and 12.

After step S60, in step S90, the scheduler 12 updates the free space management table 24.

Next, in step S92, the scheduler 12 updates the request queue 22, and returns to step S50. For example, when the corresponding prefetch is not started at the prefetch start time held in the request queue 22, the scheduler 12 updates the request queue 22 by delaying the prefetch start time held in the request queue 22. When backward propagation processing is not started at the start time of backward propagation processing held in the request queue 22, the scheduler 12 updates the request queue 22 by delaying the start time of backward propagation processing held in the request queue 22.

By updating the request queue 22 in accordance with the execution state of training of a deep neural network, the scheduler 12 may appropriately determine whether to execute offload and prefetch. The scheduler 12 may appropriately determine which one of offload and prefetch is to be prioritized.

FIG. 11 illustrates an example of the operation of step S60 in FIG. 10. First, in step S62, the scheduler 12 proceeds to step S64 when an offload request is stored in the request queue 22, or proceeds to step S68 when no offload request is stored in the request queue 22.

In step S64, the scheduler 12 proceeds to step S72 in FIG. 12 when a prefetch request is stored in the request queue 22, or proceeds to step S66 when no prefetch request is stored in the request queue 22. In step S66, the scheduler 12 executes offload of transferring a feature map from the GPU memory 40 to the CPU memory 20 in response to the offload request, and proceeds to step S90 in FIG. 10. For example, when a plurality of offload requests is stored in the request queue 22, the scheduler 12 may execute offload in order from the workload WL with the earliest start time of backward propagation processing or the earliest prefetch start time.

In step S68, the scheduler 12 proceeds to step S70 when a prefetch request is stored in the request queue 22, or proceeds to step S90 in FIG. 10 when no prefetch request is stored in the request queue 22.

In step S70, the scheduler 12 executes prefetch of transferring a feature map from the CPU memory 20 to the GPU memory 40 in response to the prefetch request, and proceeds to step S90 in FIG. 10. When a plurality of prefetch requests of which workloads WL of request sources are different from each other is stored in the request queue 22, the scheduler 12 may execute prefetch in order from the one with the earliest start time of backward propagation processing.

In step S72 in FIG. 12, the scheduler 12 determines whether the free space of the GPU memory 40 corresponding to the workload WL requesting the offload or prefetch is equal to or larger than a first threshold in the free space management table 24 in FIG. 4. When the free space is equal to or larger than the first threshold, the scheduler 12 proceeds to step S74. When the free space is smaller than the first threshold, the scheduler 12 proceeds to step S78. Although not particularly limited, for example, the first threshold is represented by a proportion of the storage capacity of the GPU memory 40, and is about 70% to 80%.

In step S74, the scheduler 12 executes prefetch in response to the prefetch request with priority over offload. When a plurality of prefetch requests of which workloads WL of request sources are different from each other is stored in the request queue 22, the scheduler 12 executes prefetch in order from the one with the earliest start time of backward propagation processing. Accordingly, the possibility that the completion timing of prefetch is not in time for the start timing of backward propagation processing using the feature map transferred by the prefetch may be reduced while giving a margin to the storage capacity of the GPU memory 40. As a result, an increase in the processing time of backward propagation may be suppressed, and a decrease in the training efficiency of a deep neural network may be suppressed.

By contrast, when the completion timing of prefetch is not in time for the start timing of backward propagation processing using the feature map transferred by the prefetch, there is a risk that an idle time is generated in the GPU 30 in which a workload WL is executed. When an idle time is generated, the execution time of deep learning by the GPU 30 increases, and the training efficiency decreases.

Next, in step S76, the scheduler 12 executes offload, and proceeds to step S90 in FIG. 10. The possibility that an idle time is generated in the GPU 30 due to a delay in offload for which the priority order is lowered is lower than the possibility that an idle time is generated in the GPU 30 due to a delay in prefetch.

In step S78, the scheduler 12 executes offload in response to the offload request with priority over prefetch. When a plurality of offload requests is stored in the request queue 22, the scheduler 12 executes offload in order from the one with the latest prefetch start time.

For example, when a feature map is used for backward propagation processing before being offloaded, the feature map may be deleted from the GPU memory 40 without being offloaded to the CPU memory 20. Accordingly, by executing offload in order from the one with the latest prefetch start time, the frequency with which a feature map does not have to be offloaded to the CPU memory 20 may be improved. As a result, the usage of the bandwidth B of the CPU memory 20 may be reduced, and the power consumed by the information processing apparatus 100 may be reduced.

Next, in step S80, the scheduler 12 executes prefetch, and proceeds to step S90 in FIG. 10.

As described above, in this embodiment, the scheduler 12 schedules data transfer based on the information held in the request queue 22 such that prefetch from the CPU memory 20 is completed by the start time of backward propagation processing. Accordingly, when data to be used in deep learning by a plurality of workloads WL is read from and written to a shared memory, the frequency of a delay in backward propagation processing due to prefetch being not in time may be reduced, and a decrease in the execution efficiency of deep learning may be suppressed.

When an offload request and a prefetch request are held in the request queue 22 and the free space of the GPU memory 40 of the workload WL of the request source of the prefetch request is equal to or larger than the first threshold, the scheduler 12 executes prefetch with priority over offload. Accordingly, prefetch of a feature map from the CPU memory 20 may be executed with a margin with respect to the start time of backward propagation processing while giving a margin to the storage capacity of the GPU memory 40. Accordingly, the possibility that the completion of prefetch of a feature map to be used for backward propagation processing is not in time for the start time of the backward propagation processing may be reduced. As a result, an increase in the processing time of backward propagation may be suppressed, and a decrease in the training efficiency of a deep neural network may be suppressed.

When an offload request and a plurality of prefetch requests are held in the request queue 22 and the free space of the GPU memory 40 of the request source of prefetch is equal to or larger than the first threshold, the scheduler 12 executes prefetch in order from the one with the earliest start time of backward propagation processing. For example, workloads WL of the request sources of a plurality of prefetch requests are different from each other. Accordingly, the possibility that the completion of prefetch is not in time for the start of backward propagation processing may be reduced. As a result, an increase in the processing time of backward propagation may be suppressed.

The scheduler 12 decreases the value of free space held in the free space management table 24 when executing offload, and increases the value of free space held in the free space management table 24 when executing prefetch. Accordingly, the scheduler 12 may determine whether the free space of each GPU memory 40 is equal to or larger than the first threshold by referring to the free space management table 24. As a result, for example, compared to a case where a free space is calculated each time, the scheduler 12 may easily determine which one of offload and prefetch is to be prioritized.

When a plurality of offload requests is held in the request queue 22 and the free spaces of the GPU memories 40 of the request sources of the plurality of offload requests are smaller than the first threshold, the scheduler 12 executes offload in order from the one with the latest prefetch start time. For example, workloads WL of the request sources of a plurality of offload requests are different from each other. Accordingly, the frequency with which a feature map does not have to be offloaded to the CPU memory 20 may be improved. As a result, the usage of the bandwidth B of the CPU memory 20 may be reduced, and the power consumed by the information processing apparatus 100 may be reduced.

When prefetch is not started at the prefetch start time held in the request queue 22, the scheduler 12 delays the prefetch start time held in the request queue 22. When backward propagation processing is not started at the start time of backward propagation processing held in the request queue 22, the scheduler 12 delays the start time of backward propagation processing held in the request queue 22. By updating the request queue 22 in accordance with the execution state of training of a deep neural network, the scheduler 12 may appropriately determine whether to execute offload and prefetch. The scheduler 12 may appropriately determine which one of offload and prefetch is to be prioritized.

The profiler 26 determines information to be held in the request queue 22 before a plurality of workloads WL executes deep learning, and the determined information is stored in the request queue 22 before forward propagation processing is executed. Accordingly, the scheduler 12 may appropriately control the operation of offload and prefetch by using the request queue 22 in which information in a state close to the state at the time of execution of deep learning is held.

Features and advantages of the embodiment are clarified from the above detailed description. The scope of claims is intended to cover the features and advantages of the embodiment as described above without departing from the spirit and scope of right of the claims. Any person having ordinary skill in the art may easily conceive every improvement and alteration. Accordingly, the scope of inventive embodiment is not intended to be limited to that described above and may rely on appropriate modifications and equivalents included in the scope disclosed in the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a plurality of calculation circuits that each executes deep learning;
a shared memory that is shared by the plurality of calculation circuits;
an access information memory that holds, for each of the plurality of calculation circuits, a write request for writing data generated in forward propagation processing by the plurality of calculation circuits to the shared memory, a read request for reading the data used in backward propagation processing by the plurality of calculation circuits from the shared memory, and a start time of backward propagation processing; and
a processor that schedules data transfer between the plurality of calculation circuits and the shared memory based on the write request, the read request, and the start time of backward propagation processing held in the access information memory such that the data is transferred from the shared memory to a calculation circuit that executes backward propagation processing by the start time of backward propagation processing, and accesses the shared memory based on a scheduling result.

2. The information processing apparatus according to claim 1,
wherein a plurality of individual memories that is included in the plurality of calculation circuits and holds the data generated in forward propagation processing and the data transferred from the shared memory, is included, and
wherein, when the write request and the read request are held in the access information memory and a free space of an individual memory of a calculation circuit of a request source of the read request is equal to or larger than a first threshold, the processor executes data transfer that corresponds to the read request with priority over data transfer that corresponds to the write request.

3. The information processing apparatus according to claim 2,
wherein, when the write request and a plurality of the read requests of which calculation circuits of request sources are different from each other are held in the access information memory and the free space of an individual memory of the calculation circuit of a request source of the plurality of read requests is equal to or larger than the first threshold, the processor executes data transfer that corresponds to a read request from one for which the start time of backward propagation processing held in the access information memory is earliest.

4. The information processing apparatus according to claim 3,
wherein a free space memory used for managing free spaces of the plurality of individual memories is included, and
wherein, when data transfer that corresponds to the write request is executed, the processor decreases a value of free space held in the free space memory corresponding to a calculation circuit of a data transfer source, and when data transfer that corresponds to the read request is executed, the processor increases a value of free space held in the free space memory corresponding to a calculation circuit of a data transfer destination.

5. The information processing apparatus according to claim 2,
wherein the access information memory holds, for each of the plurality of calculation circuits, a read time at which reading of the data from the shared memory is started, and
wherein, when the read request and a plurality of the write requests of which calculation circuits of request sources are different from each other are held in the access information memory and the free space of an individual memory of the calculation circuit of a request source of the plurality of write requests is smaller than the first threshold, the processor executes data transfer that corresponds to a write request from one for which the read time held in the access information memory is latest.

6. The information processing apparatus according to claim 5,
wherein, when data transfer that corresponds to the read request is not started at the read time held in the access information memory, the processor delays the read time held in the access information memory.

7. The information processing apparatus according to claim 1,
wherein, when backward propagation processing is not started at the start time of backward propagation processing held in the access information memory, the processor delays the start time of backward propagation processing held in the access information memory.

8. The information processing apparatus according to claim 1,
wherein information held in the access information memory is calculated based on information of forward propagation processing and backward propagation processing acquired by a profiler executed by the plurality of calculation circuits before deep learning is executed, and is stored in the access information memory.

9. An information processing method comprising:
scheduling data transfer between a plurality of calculation circuits that each executes deep learning and a shared memory that is shared by the plurality of calculation circuits based on the write request, the read request, and the start time of backward propagation processing held in an access information memory, which holds, for each of the plurality of calculation circuits, a write request for writing data generated in forward propagation processing by the plurality of calculation circuits to the shared memory, a read request for reading the data used in backward propagation processing by the plurality of calculation circuits from the shared memory, and a start time of backward propagation processing, such that the data is transferred from the shared memory to a calculation circuit that executes backward propagation processing by the start time of backward propagation processing; and
accessing the shared memory based on a scheduling result.
